(19) United States
(12) Patent Application Publication
(10) Pub. No.: US 2003/0202639 A1
(43) Pub. Date: Oct. 30, 2003

(54) Automatic telephone dialer

(76) Inventor: Hak Man Chan, Hong Kong (HK)

Correspondence Address: Thomas E. Sisson, JACKSON WALKER L.L.P., Suite 2100, 112 E, Pecan Street, San Antonio, TX, 78205, US

(21) Appl. No.: 10/134,287

(22) Filed: Apr. 29, 2002

(51) Int. Cl. H04M 11/04

(52) U.S. Cl. 379/51; 379/39

(57) ABSTRACT

An automatic telephone dialer for use in an intruder alarm system including an intruder sensor for providing an intruder signal upon sensing an intruder. The dialer comprises a body for locating a hand-held telephone, and at least one keying device supported by the body and operatively connectable to a key of the telephone located by the body for operating the key. The dialer includes an electronic controller connectable to the intruder sensor for receiving an intruder signal and in response operating the keying device to cause the telephone to dial a predetermined telephone number.

### BACKGROUND OF THE INVENTION

Nowadays, electronic anti-thief or intruder alarm systems are widely used in cars, houses, offices, shops, banks and hotels, etc. Some of these alarm systems are capable of sending an alarm signal to the owner of the premises who is remote from the premises. However, as the alarm systems of this type are often complicated in terms of structure, incorporating a specific telephone dialing circuit, they are relatively expensive for domestic use, such as in a car or at home.

The invention seeks to provide a structurally simplified automatic telephone dialer for use in an intruder alarm system.

### SUMMARY OF THE INVENTION

According to the invention, there is provided an automatic telephone dialer for use in an intruder alarm system including an intruder sensor for providing an intruder signal upon sensing an intruder. The dialer comprises a body for locating a hand-held telephone, and at least one keying device supported by the body and operatively connectable to a key of the telephone located by the body for operating the key. The dialer includes an electronic controller connectable to the intruder sensor for receiving an intruder signal and in response operating the keying device to cause the telephone to dial a predetermined telephone number.

In a first preferred embodiment, the keying device comprises an electro-mechanical device for closing the key of said telephone.

More preferably, the electro-mechanical device comprises a solenoid including an actuating member for operatively connecting and thus pressing to close the key of said telephone.

Further more preferably, the actuating member of the solenoid is spring-loaded into a normally retracted position so as not to operate the key of said telephone.

It is preferred that the body comprises a clamp for gripping said telephone.

It is further preferred that the clamp comprises a pair of clamping members, at least one of which is manually adjustable in position to locate said telephone.

Preferably, the body includes a bracket locating the keying device in a position close proximal to the key of said telephone.

More preferably, the bracket is manually adjustable in position in a direction substantially perpendicular to a plane on which the key of said telephone lies.

In a second preferred embodiment, the keying device comprises an associated switch having a pair of terminals electrically connectable to respective contacts of the key of said telephone for closing the key.

More preferably, the keying device comprises a relay.

It is preferred that the aforesaid automatic telephone dialer includes at least two said keying devices which are operatively connectable to a call sending key and a call ending key of said telephone located by the body.

The invention also provides an intruder alarm system incorporating the aforesaid automatic telephone dialer, including an intruder sensor connected to the electronic controller and an alarm for providing an audio alarm signal upon the intruder sensor sensing an intruder.

### BRIEF DESCRIPTION OF DRAWINGS

The invention will now be more particularly described, by way of example only, with reference to the accompanying drawings, in which:

FIG. 1 is a schematic diagram of an embodiment of an automatic telephone dialer in accordance with the invention;

FIGS. 2 to 4 are top plan, side and end views showing the actual construction of the dialer of FIG. 1;

FIGS. 5 to 7 are schematic diagrams showing the operation of the dialer of FIGS. 2 to 4;

FIG. 8 is a schematic diagram of an intruder alarm system incorporating the dialer of FIGS. 2 to 4; and

FIG. 9 is a schematic diagram similar to FIG. 8, in which the intruder alarm system incorporates a dialer that is slightly modified from that of FIGS. 2 to 4.

### DETAILED DESCRIPTION OF PREFERRED EMBODIMENTS

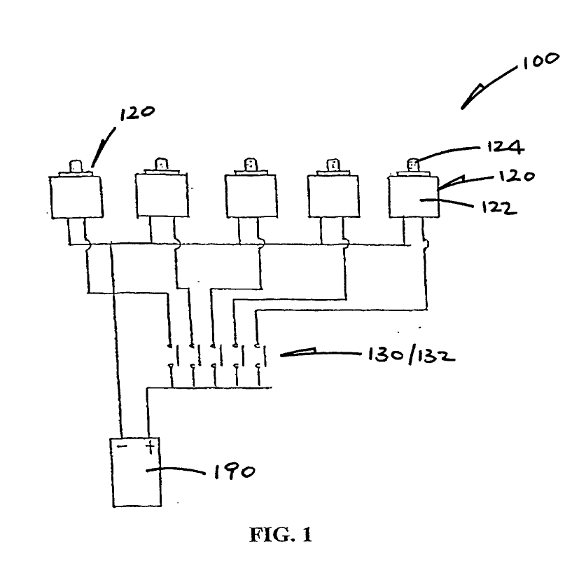

Referring initially to FIG. 1 of the drawings, there is shown an automatic telephone dialer 100 embodying the invention for use in an intruder (or burglar) alarm system, for a car or home for example, including an intruder sensor for providing an intruder signal upon sensing an intruder. The dialer 100 comprises five keying devices 120 which are arranged, for operation, to connect or engage with respective keys of an existing hand-held telephone such as a cordless or mobile phone (not yet shown) for pressing the keys. The dialer 100 further comprises a controller 130 which may be implemented by an electronic circuit or a computer and includes five switches 132 associated with the keying devices 120 respectively.

The controller 130 is arranged to be connected to the intruder sensor for receiving an intruder signal therefrom and, in response, closing the relevant switches 132 to operate the corresponding keying devices 120, as appropriate, to cause the mobile phone to dial a predetermined telephone number. The keying devices 120 and controller 130 are powered by a DC power supply 190.

Each keying device 120 is implemented by an electro-mechanical device for closing the corresponding key of the mobile phone. The electro-mechanical device is in the form of a solenoid which comprises a cylindrical coil of wire 122 and includes an actuating rod (or plunger) 124 extending co-axially within the coil 122. The rod 124 is spring-loaded into a normally retracted position relative to the coil 122 so as not to press the key of the mobile phone, and is arranged to project outwards, upon energization of the coil 122, to connect or press and thus close the key of the mobile phone.

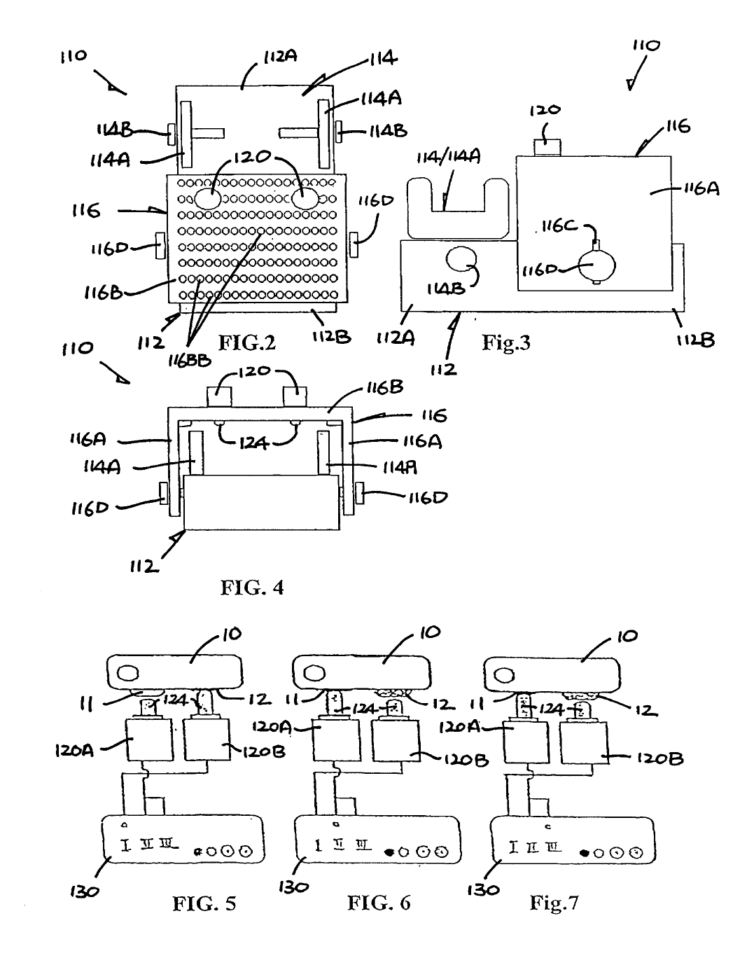

Referring also to FIGS. 2 to 7, which shows the actual physical construction of the automatic telephone dialer 100, but in this particular instance only two keying devices 120, or 120A and 120B, have been employed. The dialer 100 includes a body or station 110 housing the controller 130 and for locating a mobile (or cordless) phone 10 having a call sending key 11 and a call ending key 12.

The station 110 comprises a rectangular platform 112 for supporting the mobile phone 10, which is to rest on the platform 112 with its keypad including the call sending and ending keys 11 and 12 lying in a horizontal plane facing upwards. The station 110 includes a clamp 114 provided on a front end 112A of the platform 112 for gripping the mobile phone 10.

The clamp 114 has a pair of opposite, left and right vertical flat U-shaped clamping members 114A, both of which are slidable horizontally towards each other to grip and locate the mobile phone 10 (whose width changes from one model to another) on the platform 112, or away from each other to release the phone 10. The position of each clamping member 114A is manually adjustable by means of a respective horizontal screw 114B provided on the corresponding side of the platform end 112A. The screw 114B has an inner end engaged with the clamping member 114A and an outer end that is screwed threaded with the side wall or an internal fixed nut member of the platform 112.

The station 110 includes a bracket 116 provided on a rear end 112B of the platform 112, which locates the two keying devices 120A and 120B in a position close proximal to the corresponding keys 11 and 12 of the mobile phone 10. The bracket 116 is inverted U-shaped, having a pair of opposite, left and right vertical planar legs 116A embracing the platform end 112B from above and including a top planar bridge 116B linking the two legs 116A. The bridge 116B is formed with an array of many holes 116BB.

The two keying devices 120A and 120B are mounted on the bridge 116B, facing downwardly with their actuating rods 124 passing through respective selected holes 116BB of the bridge 116B. The selected holes 116BB are chosen such that the two rods 124 are aligned with the call sending and ending keys 11 and 12 of the mobile phone 10 for operation.

Each leg 116B is formed with a short vertical slot 116C, through which a horizontal screw 116D passes, said screw 116D being then screwed threaded with the side wall or an internal fixed nut member of the platform 112. Upon tightening, the screws 116D fix the legs 116A and in turn the overall bracket 116 relative to the platform 112. The level of the bridge 116B relative to the mobile phone 10 can be manually adjusted, as enabled by the slots 116C in a direction perpendicular to the plane of the phone keys 11 and 12. This ensures that the actuating rods 124 are extendable downwards to press the corresponding keys 11 and 12 of the phone 10, whose thickness changes from one model to another. The inner corners of the bracket 116 are fitted with sponge mats 116E to protect the phone 10.

Upon receiving an intruder signal from the intruder sensor, the controller 130 initially energizes the second keying device 120B to press the call ending key 12 momentarily for resetting the mobile phone 10 if necessary (FIG. 5). The first keying device 120A will subsequently be energized twice to press the call sending key 11 two times to recall and then dial the last dialed telephone number (FIGS. 6 and 7). The redialed number has been predetermined as the party who should be called in the case of an intruder, such as the owner of the car or home, or the security centre or police station.

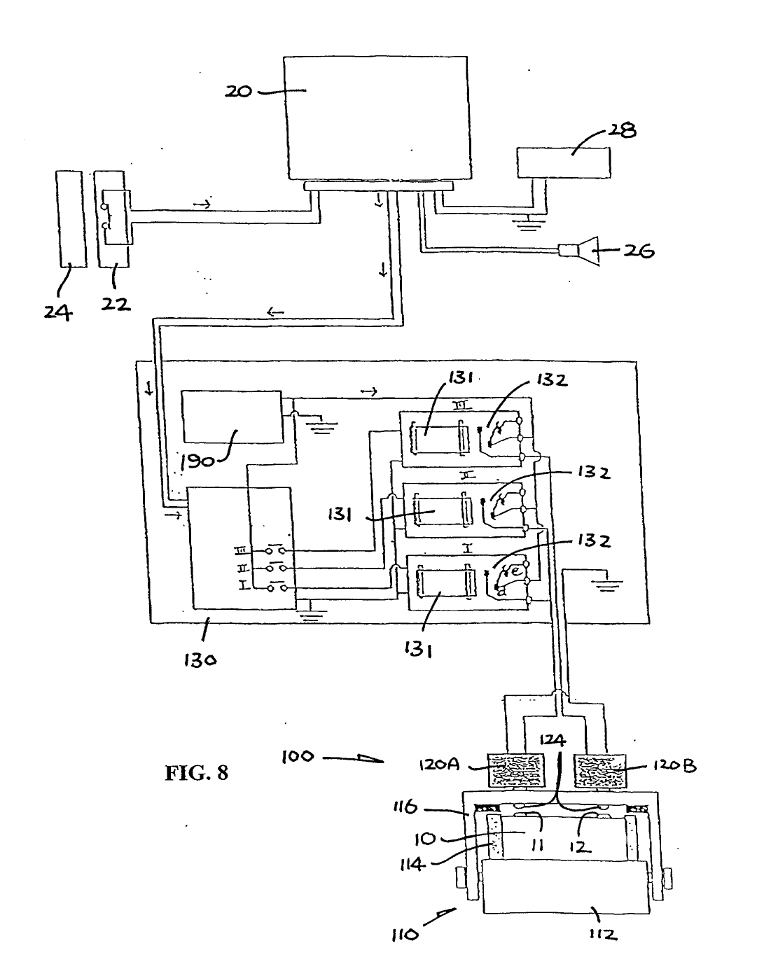

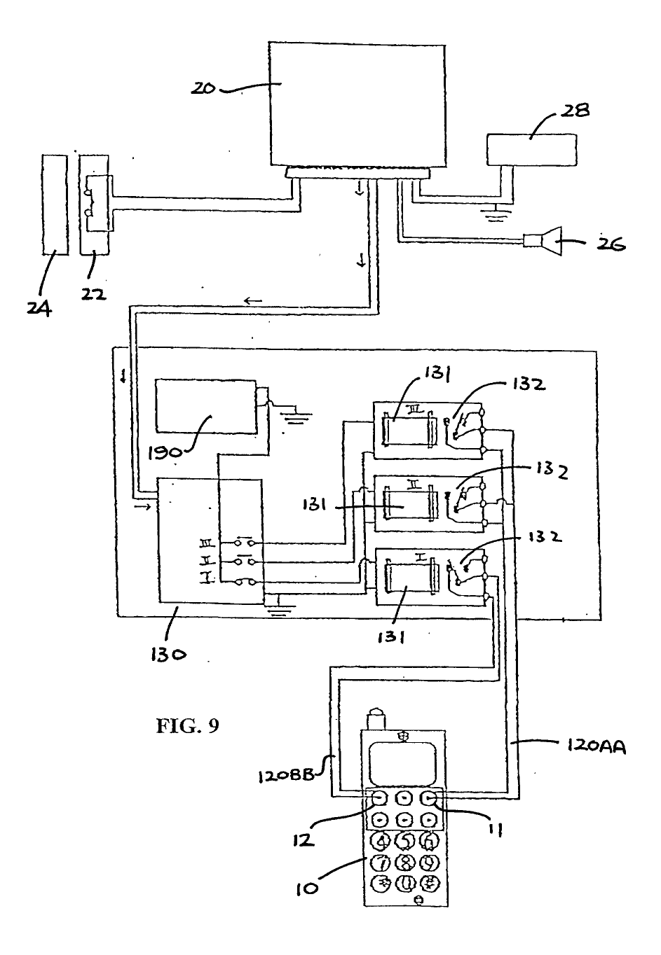

FIG. 8 shows the entire intruder alarm system in which the automatic telephone dialer 100 is used. The system includes a system control unit 20, an intruder sensor 22 installed at a door/window 24 of the car or home, an alarm 26 connected to the control unit 20, and a power supply 28 powering the control unit 20, all of which can be standard equipment and devices. The intruder sensor 22 is connected to the controller 130 of the dialer 100 via the control unit 20. The alarm 26 is in the form of a horn which will provide an audio alarm signal at the same time as the dialer 100 upon the intruder sensor 22 sensing an intruder.

More specifically, the controller 130 incorporates three relays 131 including respective switches 132 for operating the two keying devices 120A and 120B to perform the three keying actions as described in relation to FIGS. 5 to 7.

Reference is finally made to FIG. 9, which shows a slightly modified embodiment of the automatic telephone dialer 100, with equivalent parts designated by the same reference numerals. In this embodiment, the two mechanical keying devices 120A and 120B as described above are replaced and implemented by the three relays 131 whose switches 132 are connected by two pairs of electrical wires 120AA and 120BB to the corresponding call sending and ending keys 11 and 12 of the mobile phone 10.

Each switch 132 of two of the relays 131 has a pair of terminals connected by the first pair of wires 120AA to respective internal contacts of the call sending key 11. Upon closing, either one switch 132 will short-circuit the contacts of the phone key 11, thereby in effect pressing the key 11. The two switches 132 closing momentarily one after the other will simulate double pressing of the call sending key 11 to redial the last telephone number as described in relation to FIGS. 6 and 7.

The switch 132 of the other relay 131 has a pair of terminals connected by the second pair of wires 120BB to respective internal contacts of the call ending key 12. Upon closing, the switch 132 will short-circuit the contacts of the call ending key 12, thereby in effect pressing the key 12 once to reset the mobile phone 10 if necessary as described in relation to FIG. 5.

It is envisaged that the automatic telephone dialer 100 may have any number of keying devices 120 as required according to how the controller 130 is programmed to press the keypad, including the call sending and ending keys 11 and 12, of the mobile/cordless phone 10. The described last number redial action requires simple programming of the controller 130. If the telephone 10 has a quick dial function, any one of the appropriate keys may be preset to dial a predetermined number upon prolonged depression, and in this case only one keying device 120 will be sufficient.

It is further envisaged that in the embodiment of FIG. 9, the relays 131 and their associated switches 132 may be replaced by solid-state switches.

The automatic telephone dialer of the subject invention has a simple and hence inexpensive construction, and is reliable in sending out an alarm call through the use of any existing hand-held telephone and the public telephone network. An outdated mobile phone may be used, which will otherwise be discarded usually.

The invention has been given by way of example only, and various modifications and/or variations to the described embodiments may be made by persons skilled in the art without departing from the scope of the invention as specified in the accompanying claims.

1. An automatic telephone dialer for use in an intruder alarm system including an intruder sensor for providing an intruder signal upon sensing an intruder, said dialer comprising a body for locating a hand-held telephone, at least one keying device supported by the body and operatively connectable to a key of said telephone located by the body for operating said key, and an electronic controller connectable to said intruder sensor for receiving said intruder signal and in response operating the keying device to cause said telephone to dial a predetermined telephone number.

2. The automatic telephone dialer as claimed in claim 1, wherein the keying device comprises an electro-mechanical device for closing the key of said telephone.

3. The automatic telephone dialer as claimed in claim 2, wherein the electro-mechanical device comprises a solenoid including an actuating member for operatively connecting and thus pressing to close the key of said telephone.

4. The automatic telephone dialer as claimed in claim 3, wherein the actuating member of the solenoid is spring-loaded into a normally retracted position so as not to operate the key of said telephone.

5. The automatic telephone dialer as claimed in claim 1, wherein the body comprises a clamp for gripping said telephone.

6. The automatic telephone dialer as claimed in claim 5, wherein the clamp comprises a pair of clamping members, at least one of which is manually adjustable in position to locate said telephone.

7. The automatic telephone dialer as claimed in claim 5, wherein the body includes a bracket locating the keying device in a position close proximal to the key of said telephone.

8. The automatic telephone dialer as claimed in claim 7, wherein the bracket is manually adjustable in position in a direction substantially perpendicular to a plane on which the key of said telephone lies.

9. The automatic telephone dialer as claimed in claim 1, wherein the keying device comprises an associated switch having a pair of terminals electrically connectable to respective contacts of the key of said telephone for closing the key.

10. The automatic telephone dialer as claimed in claim 9, wherein the keying device comprises a relay.

11. The automatic telephone dialer as claimed in claim 1, including at least two said keying devices which are operatively connectable to a call sending key and a call ending key of said telephone located by the body.

12. An intruder alarm system incorporating the automatic telephone dialer as claimed in claim 1, including an intruder sensor connected to the electronic controller and an alarm for providing an audio alarm signal upon the intruder sensor sensing an intruder.
